(19) United States
(12) Patent Application Publication
(10) Pub. No.: US 2012/0080106 A1
(43) Pub. Date: Apr. 5, 2012

(54) RESERVOIR FOR RECEIVING A FLUID

(75) Inventors: Dragan Griebel, Schonwald (DE); Volker Böhm, Sparneck (DE); Alexander Oelschlegel, Konradsreuth (DE); Norbert Honheiser, Selbitz (DE)

(73) Assignee: REHAU AG & CO, Rehau (DE)

(21) Appl. No.: 13/376,396

(22) PCT Filed: Jun. 14, 2010
(86) PCT No.: PCT/EP2010/003561

§ 371 Date: Dec. 6, 2011

(30) Foreign Application Priority Data
Jun. 16, 2009 (DE) 10 2009 025 386.6

(51) Int. Cl. F15D 1/00; B29C 49/00; B65D 85/00

(52) U.S. Cl. 137/561 R; 206/524.6; 264/523

(57) ABSTRACT

The reservoir according to the invention for receiving a fluid, in particular under a pressure that is elevated relative to the surroundings, comprises a hollow body that is delimited by a wall having a multi-layered structure, and a device for feeding the fluid to and carrying the fluid away from the hollow body, and is characterized in that the inner layer of the wall contains cross-linked polyethylene.

The invention relates to a reservoir for receiving a fluid, in particular under a pressure that is elevated relative to the surroundings, the reservoir comprising a hollow body that is delimited by a wall, wherein the wall has a multi-layered structure, and a device for feeding the fluid to and carrying the fluid away from the hollow body.

The invention further relates to a method for producing such a reservoir.

Finally, the invention relates to a fluid supply system comprising at least one such reservoir.

Reservoirs for receiving gaseous or liquid media under pressure which comprise a hollow body having a multi-layered structure are known from the prior art.

Such reservoirs are used, for example, for supplying the internal combustion engine in motor vehicles, wherein the reservoir contains and provides gaseous or liquid combustible substances.

In particular gases are received here in such reservoirs under very high pressures which can easily reach up to 1500 bar.

It is further known from the prior art that the wall of the reservoir consists of an inner layer which, for example, is made of metal or a polymer material, and that there is an outer layer that represents a reinforcement layer.

A disadvantage of this known prior art is that during the refueling process in which, for example, a gas is introduced into the reservoir under high pressure and high velocity, heat is generated which in some cases can damage the inner wall of the reservoir if the latter consists of polymer material.

Proceeding from this prior art, it is an object of the invention to provide a reservoir for receiving a fluid which permits performing fast refueling processes without experiencing damage due to heat generated thereby.

It is a further object of the invention to provide a production method for such a reservoir; finally, it is also an object of the invention to propose a fluid supply system comprising at least on such reservoir.

The object is achieved in that a reservoir is provided for receiving a fluid, in particular under a pressure that is elevated relative to the surroundings, wherein the reservoir comprises a hollow body that is delimited by a wall. The wall has a multi-layered structure. Provided therein is a device for feeding the fluid to and carrying the fluid away from the hollow body.

The reservoir for receiving the fluid is characterized in that the inner layer of the wall contains cross-linked polyethylene.

With the selection according to the invention of cross-linked polyethylene for the inner layer of the wall which is also designated as “liner”, a reservoir is made available which permits performing fast refueling processes, wherein the heat generated thereby does not result in damaging effects on said liner. In particular, no thermal deformation of the liner takes place; the material cannot “flow away” under the influence of heat.

The inner layer of the reservoir, the liner, is produced using a blow molding method. For this, a tube is extruded using a method known per se and is then enclosed by means of a molding tool and molded by blowing in a gas. Said liner preferably has a shape which comprises an elongated cylindrical section and two approximately hemispherical so-called terminal caps delimiting said cylindrical section.

Within the context of the invention, it can advantageously be provided that the polyethylene of the liner is peroxide cross-linked, or silane cross-linked, or cross-linked under the influence of radiation energy.

Particularly preferred here is peroxide cross-linking of polyethylene, forming so-called PE-Xa, wherein cross-linking of the polyethylene takes place under elevated temperature by means of radical-forming peroxides.

When cross-linking polyethylene, chemical compounds between adjacent polymers chains are established so that a highly ductile and particularly temperature-stable polymer material is created which is perfectly suited for the above-described intended use.

The degree of cross-linking of the polyethylene can be controlled through selection and quantity of the peroxide and furthermore through the parameters of the cross-linking process. According to the present invention, the degree of cross-linking of the polyethylene can be 5 to 95%, preferably 15 to 90% and particularly preferably 50 to 85%.

Cross-linking degrees in this range result in the high thermal stability of the wall. “Creeping” of the material as it is known from thermoplastics is therefore prevented.

The polyethylene used as a polymer material for producing the hollow body using the blow molding method is a so-called blow-moldable polyethylene.

For this, an adequate low-viscous polyethylene is selected; the MFI is 0.1 to 2 g/10 min at 190° C., the load is 2.16 kg. The density of such a blow-moldable polyethylene is 0.93 to 0.965 g/cm³, preferred 0.948 to 0.960 g/cm³.

For blow-molding and subsequent cross-linking, in particular so-called “Philips” types are preferred for this purpose. Such Phillips types are produced by means of a silicate supported chromium catalyst using a polymerization method.

Besides polyethylene, a polyethylene copolymer can also be used for blow-molding; preferred here is a comonomer of a polyolefin based on a C3 to C8 building block.

In order that the polyethylene can be cross-linked, a cross-linking agent, in the present case an organic peroxide, is added to the polyethylene.

Organic peroxides are particularly suitable for cross-linking polyethylene.

According to the invention, organic peroxides are used here which have a typical cross-linking temperature of greater than or equal to 170° C.

Particularly preferred are such peroxides which have a cross-linking temperature of greater than or equal to 175° C.

In this manner, a particularly uniform and high-grade cross-linking of the polyethylene is achieved.

Further components may be additionally added to the polyethylene.

These components can comprise, for example, stabilizers such as, e.g., phenolic antioxidants, or processing aids such as, for example, antiblocking agents, or cross-linking enhancers such as, for example, TAC (triallyl cyanurate), or TAIC (triallyl isocyanurate), or trimethylolpropane trimethacrylate, or divinylbenzene, or diallyl terephthalate, or trilallyl trimellitate, or triallyl phosphate in concentrations of 0.2 to 2.0 percent by weight.

For cross-linking, the hollow body produced with the blow molding method using polyethylene is exposed over a certain period to elevated temperature.

This can comprise, for example, a period of 10 min at a temperature of 180° C. to 280° C.

During the cross-linking process, in order to prevent collapsing or a dimensional change of the hollow body produced with the blow-molding method using polyethylene, the hollow body can be pressurized during cross-linking by means of continuous overpressure of the blow air (support air) which presses the hollow body into a mold defining the outer contour.

When cross-linking the polyethylene into PE-Xb which is formed by silane cross-linking, first, the so-called two-stage process is to be considered.

The latter is also called the Sioplas process.

For this, the polyethylene is first grafted with a silane with the aid of peroxides; this grafted polyethylene is then mixed with a catalyst batch and thus can be used for producing the hollow body with the blow-molding method.

Suitable as a catalyst batch is an organotin compound such as, for example, DOTL (dioctyltin laurate).

Further additives in this composition of grafted polyethylene and the catalyst batch can be additionally contained.

It is also possible to carry out grafting of the silane onto the polyethylene by using a so-called single-stage method. For this, a mixture of polyethylene, silane, peroxide and the catalyst is fed to an extruder. Silane, peroxide, and the catalyst form a liquid phase which is added to the polyethylene.

Through a so-called reactive extrusion, first, grafting the silane onto the polyethylene is performed, wherein a homogenous mixing with the catalyst takes place at the same time.

Cross-linking the polyethylene takes place in presence of humidity at elevated temperature; this is usually carried out in a steam atmosphere or in a water bath of 90 to 105° C. over a period of 6 to 15 hours, depending on the wall thickness of the hollow body to be blow molded.

It is also possible to cross-link polyethylene under the influence of radiation energy; this is then referred to as PE-Xc.

For this, substantially all polyethylenes and copolymers thereof are suitable.

Cross-linking of the polyethylene is achieved through the effect of electron beams or gamma beams.

Also, TAC or TIAC can be supportive during cross-linking.

Finally, it is also possible to cross-link polyethylene by using UV light in that so-called photoinitiators, for example substituted benzophenones and similar substances, are added to the polyethylene which start the cross-linking reaction under the influence of UV light.

Besides the inner layer of the wall from cross-linked polyethylene, the reservoir has an outer layer of the wall. The outer layer of the wall contains a filament or thread that consists, for example, of carbon, or of aramid, or of metal, or of boron, or of glass, or of a silicate material, or of aluminum oxide, or of a highly ductile and highly temperature-resistant polymer material, or of a mixture of the aforementioned materials. The latter are also called hybrid yarns.

This fiber reinforcement of the outer layer of the wall further contains a polymer material, preferably an epoxy resin.

Said filaments or threads which are contained in the outer layer of the wall are wrapped and/or braided around the inner layer of the wall of the hollow body.

The wrapping can in particular be provided in such a manner that it is formed so as to be stronger at the terminal caps of the reservoir so as to achieve there a particularly high stability.

Also, it can advantageously be provided that the wrapping is formed so as to be particularly strong in the region of the device for feeding and/or carrying away the fluid or at other places in order to strengthen the reservoir at this place.

Likewise, it can be advantageous if at the terminal caps of the reservoir, and/or in the region of the device for feeding and/or carrying away the fluid, or at other places, a specific braiding technique is used which differs from the braiding technique that is used at the cylindrical section of the reservoir. Such a specific braiding technique can give the outer layer on the wall a particular high strength.

According to the invention it can be provided that the outer layer is not connected to the inner layer. This can offer advantages in terms of long-term stability of the reservoir.

In another embodiment of the invention, it is also possible that the inner layer is connected to the outer layer. In this manner, a particularly durable reservoir can be created.

Furthermore, the reservoir has a device for feeding the fluid to and carrying the fluid away from the hollow body. This so- called “boss” is an opening in the wall of the reservoir which serves for filling the reservoir with the fluid to be received or for emptying it.

It can advantageously be provided that at a location of the surface of the reservoir, located approximately opposite to said “boss”, a means is provided that facilitates applying the outer layer by wrapping and/or braiding.

Said means can be a projection of the surface or can comprise an indentation provided therein in which, for example, an axle can be introduced, or a similar configuration.

With the aid of said means, the reservoir is then easier to handle for the wrapping or braiding operation. For example, said means can serve for centering the reservoir during the wrapping and/or braiding operation. Also, it can advantageously be used as a wrapping fixture in order to move the reservoir. Finally, said means can also be used for fixing the reservoir during the subsequent use.

Thus, this results in a better quality of the outer layer to be applied. The reservoir can therefore be produced to be more durable.

In a preferred refinement of the invention, a barrier layer may be provided that reduces the diffusion of the fluid through the wall.

It is hereby made possible that a reservoir is created which has a particularly low leakage rate and is in particular capable of receiving the fluid to be stored for a very long time without significant pressure losses.

For this purpose, the barrier layer may be arranged on the inner surface of the inner layer.

In this manner, a diffusion of the fluid through the container wall is reliably avoided.

The barrier layer according to the invention may be a polymer such as, for example, ethylene vinyl alcohol (EVOH), or a film, or a coating, in particular based on a silazane, or a combination of the aforementioned. The thickness of the barrier layer can be between 0.1 and 1000 μm, preferred between 0.5 and 1.5 μm.

Depending on the fluid to be stored, a particularly advantageous reduction of the diffusion through the wall can be achieved through the selection of the type of barrier layer and the respective thickness of the barrier layer.

Thus, it is possible, for example, to reduce the diffusion of hydrogen through the wall of such a reservoir very effectively in that a layer of the silazane is applied onto the inner surface of the inner layer, wherein the thickness of said barrier layer is 0.5 μm to 1.5 μm.

In a refinement of the present invention, the reservoir may have an outer protective layer which is applied onto the outer layer of the wall.

The outer protective layer can contain a thermoplastic, or a coextrudate, or a shrink tubing, or a knitted fabric, or an interlaced fabric, or a meshwork, or a combination of the aforementioned.

Such an outer protective layer of the reservoir is advantageous if the latter is exposed to a mechanical load such as, for example, impacts or similar forces acting thereupon.

Such an outer protective layer prevents in particular damage, for example to the outer wall, that can occur which could result in breaking said wall.

The outer protective layer can also be configured such that it forms a fire protection layer which protects the reservoir effectively against the influence of fire. For this, it can advantageously be provided that the fire protection layer contains so-called intumescent materials which, under the influence of elevated temperature, release gases or water and thus cool the reservoir and/or shield it against the influence of hot gases, and/or by forming a heat-insulating layer with low heat conductivity, protecting the reservoir for a certain time against the influence of heat.

Such intumescent materials are, for example:

Compositions, the compositions comprising a “carbon” donor (e.g. polyalcohols), an acid donor (e.g. ammonium polyphosphate), and a propellant (e.g. melamine). The latter then form a voluminous, insulating protective layer by carbonization and simultaneous foaming.

Other intumescent materials comprise, for example, hydrates which, under the influence of heat, develop an endothermic effect by releasing cooling vapor. An example for this is hydrated alkali metal silicate.

Also known are gas-releasing intumescent materials which comprise, for example, melamine, methylolated melamine, hexamethoxymethylmelamine, melamine monophosphate, melamine biphosphate, melamine polyphosphate, melamine pyrophosphate, urea, dimethylurea, dicyandiamide, guanyl urea phosphate, glycine, or amine phosphate. The aforementioned materials release gaseous nitrogen when they decompose under the influence of heat. Compounds which release carbon dioxide or water vapor under the influence of heat could also be used.

The outer protective layer can also serve for identifying the reservoir by recording or imaging information which is applied in alphanumeric form, or as a barcode, or as a color code.

Finally, the outer protective layer can also be provided for giving the reservoir an attractive appearance.

Also, in one refinement of the invention, a metal layer can be provided.

Said metal layer can be arranged on the inner layer. The metal layer is preferably configured such that it does not resist the diffusion of the fluid through the wall of the reservoir.

For this purpose, the metal layer can be perforated, for example, or is disposed only in certain sections.

In this way, it is possible to produce a particularly robust reservoir.

In another embodiment, the metal layer can also be provided on the reinforcement layer.

Thereby, a reservoir having a particularly strong wall is obtained.

Finally, the metal layer can also be arranged on the outer layer of the reservoir.

In this case, the reservoir is specifically protected against external influences such as impacts or forces acting thereupon.

In one refinement of the invention, the reservoir may have fastening means which are fastened on the outer wall. Said means can comprise brackets or strips made of metal or polymer material. In particular, the reservoir can have fastening means which are formed on the outer layer of the wall. Also, it can advantageously be provided that fastening means are formed on the outer protective layer.

In this way, the reservoir can be fastened in an advantageous manner, for example, in an installation situation in a vehicle.

In one refinement of the invention it can be provided that the reservoir has a sensor element in or on at least one layer of the wall. Said sensor element, for example, can be a strain gauge which, in case of a length change, outputs information via a signal connection.

Thus, in the event of damage, for example if the reservoir is overstretched or mechanically damaged due to a malfunction or an operating error, a display can be triggered which disables a continued operation of the reservoir and thus averts dangers.

Also, in one refinement of the invention, the reservoir can include an identification element which clearly characterizes the reservoir and stores and provides data.

This can comprise data on the reservoir's history of origins (life cycle during production and use), on its operation, or on other conditions.

Said identification element can be, for example, a barcode, an alphanumeric code, an embossed or recessed element, a hologram, a color element, or an RFID element (Radio Frequency Identification Device, identification by means of electromagnetic waves), or a similar element.

Thus, it is possible to enable and/or ensure quality assurance for the reservoir as well as tracking of its operation.

The method for producing the reservoir according to the invention is characterized in that the inner layer is produced by means of the blow molding method using polyethylene and is cross-linked after molding.

It is possible hereby to produce a liner which, with respect to its dimensions, is built very precisely and thus meets the high safety requirements to be fulfilled by said liner.

Furthermore, the cross-linking process is not started until the component has already assumed its shape, which results in advantages in terms of quality and uniformity of the cross-linking.

It is particularly advantageous here if the liner, which is produced using the blow molding method, is stabilized by overpressure (support air) in a mold, wherein cross-linking is carried out under elevated temperature.

The support air prevents the liner from collapsing while the polyethylene is transferred by the running cross-linking process into a solid state.

Also, the blow molding method for producing the liner can be advantageously configured here in such a manner that a plurality of forming tools are provided which, in a continuous succession, blow up the extruded tube to form the desired hollow body and, after cross-linking and removal of the part, are then is immediately available again for manufacturing the next component.

Depending on the number of tools available, manufacturing of liners thus can be implemented in a high cycle sequence. This can be implemented, for example, in a rotary machine.

A fluid supply system according to the invention comprising at least one reservoir of the above-described type is preferably used for a motor vehicle in the form of a stationary or mobile, in particular, decentralized energy generating device or an energy storage system.

The reservoir serves in particular for receiving hydrogen under a pressure that can be up to 1500 bar.

The present invention is described in more detail with reference to the figures.

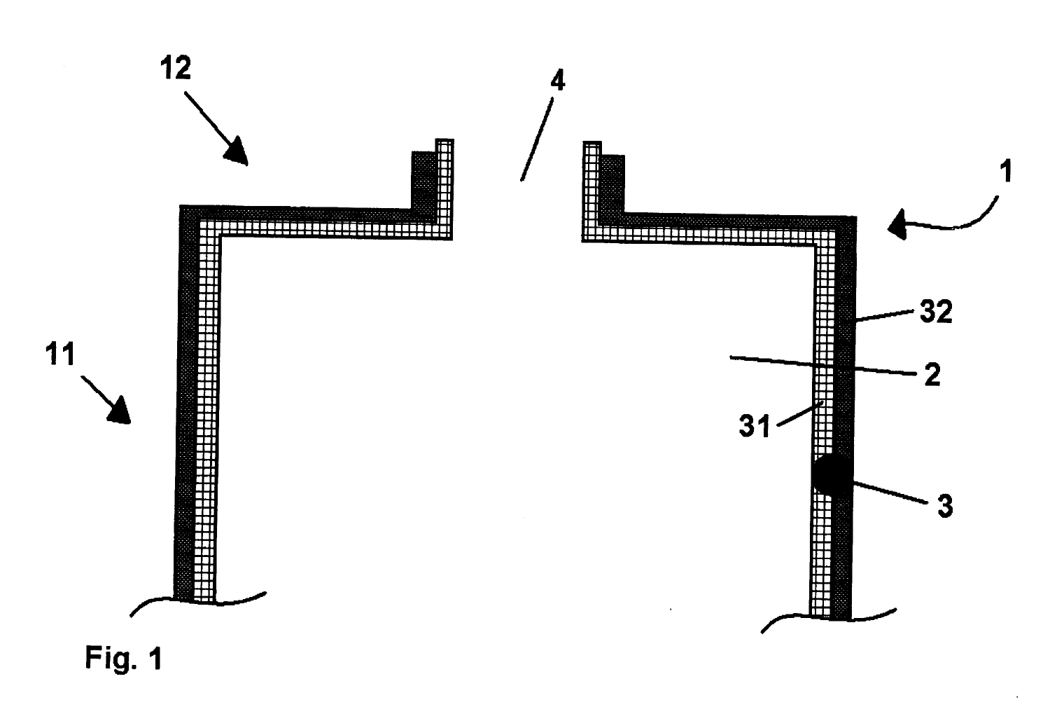

FIG. 1 shows a schematic sectional illustration of a section of a reservoir according to the invention;

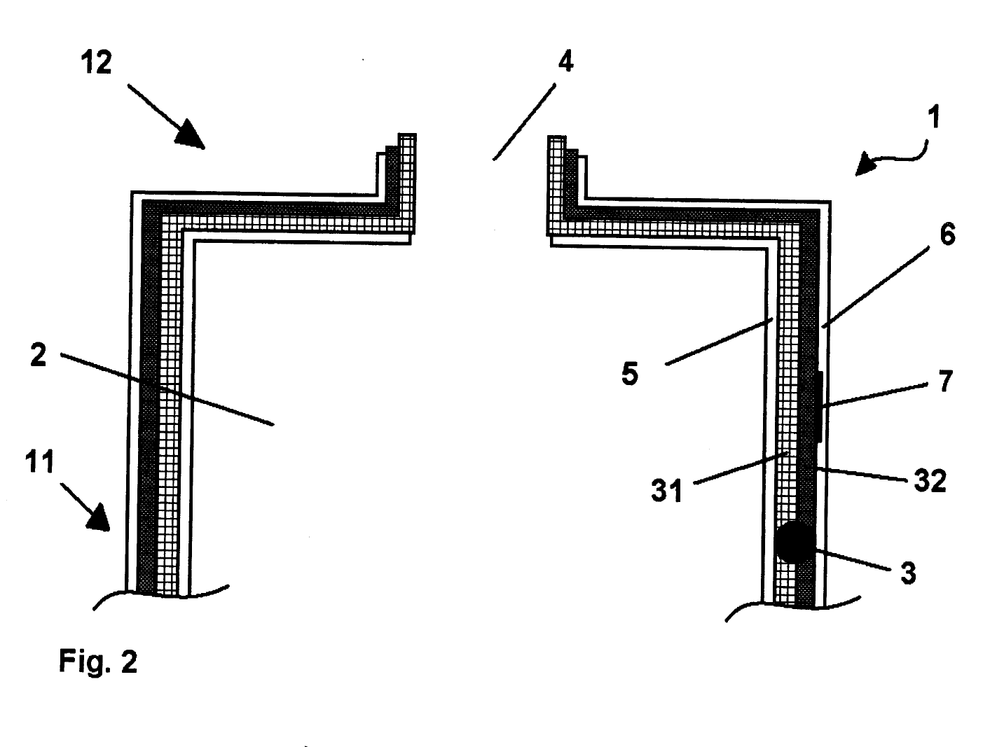

FIG. 2 shows a schematic sectional illustration of a section of a second reservoir according to the invention.

FIG. 1 schematically shows a section of a reservoir according to the invention in a sectional illustration.

Said reservoir 1 has substantially an elongated structure in the form of a cylindrical middle section 11 which has terminal caps 12 (only one is shown in the Fig.) molded thereon on both cylinder ends.

On a terminal cap 12, the device 4 for feeding and carrying away the fluid is formed.

The hollow body 2 of the reservoir 1 is enclosed by a multi-layered wall 3 having an inner layer 31 which contains cross-linked polyethylene.

The inner layer 31 is produced in one piece by means of a blow-molding method using polyethylene and is subsequently cross-linked.

Said inner layer 31 has substantially the same wall thickness everywhere.

The outer layer 32 of the wall 3 is a reinforcement layer.

This reinforcement layer is generated by wrapping and/or braiding of threads or fibers; said layer is reinforced by a thermoset material, in the present case by an epoxy resin.

Depending on the requirements for the stability at different sections, the outer layer 32 has different thicknesses. The Fig. shows that the outer layer 32 is thickened in the region of the device 4 for feeding and carrying away the fluid because there, forces occur which are to be absorbed by the outer layer 32.

The outer layer 32 is not connected to the inner layer 31.

FIG. 2 schematically shows a section of the second reservoir according to the invention in a sectional illustration.

On a terminal cap 12, a device 4 for feeding and carrying away the fluid is formed.

The Fig. further shows that on the inner surface of the inner layer 31, a diffusion barrier layer 5 is arranged which effectively reduces or prevents the diffusion of the fluid from the hollow body 2 through the wall 3.

In the present example, the diffusion barrier layer 5 is a layer of silazane.

On the outer layer 32, a protective layer 6 is arranged which is configured in the form of a shrink tubing which largely encloses the reservoir.

In the present exemplary embodiment, a sensor element 7 which is arranged approximately in the middle section 11 rests on the outer layer 32 and is configured as a strain gauge. Said sensor element 7 is capable, via signal lines which are not shown here or, alternatively, contactless, to output a signal about the state of the reservoir 1 which provides information by means of an evaluation electronics, which is not shown here, and which indicates, for example, if the reservoir 1 is damaged.

### EXEMPLARY EMBODIMENT

A blow-moldable polyethylene having a MFI of 0.3 g/10 min at 190° C. with an applied load of 2.16 kg is processed using the blow-molding method to form a liner.

The density of the blow-moldable polyethylene is 0.95 g/cm³.

The blow-moldable polyethylene contains an organic peroxide which has a cross-linking temperature of 175° C.

After the forming operation, the blow-molded hollow body is exposed to a temperature of 240° C. over a period of 5 min for the purpose of cross-linking. For this, the hollow body is protected by support air in the mold against potential dimensional changes.

After the hollow body is cooled down, said hollow body is wrapped with carbon fibers soaked in epoxy resin until a layer thickness of 15 to 45 mm is reached.

The reservoir produced in this manner resists a pressure of the fluid stored therein of 1000 bar. The reservoir can be filled with hydrogen, wherein a pressure of 700 bar can be built up within 3 to 5 min.

### Reference List

1 Reservoir

11 Middle section

12 Terminal cap

2 Hollow body

3 Wall

31 Inner layer

32 Outer layer

4 Device for feeding and carrying away the fluid

5 Diffusion barrier layer

6 Protective layer

7 Sensor element

1. A reservoir for receiving a fluid, in particular under a pressure that is elevated relative to the surroundings, the reservoir comprising a hollow body that is delimited by a wall having a multi-layered structure, and a device for feeding the fluid to and carrying the fluid away from the hollow body, wherein the inner layer of the wall contains cross-linked polyethylene.

2. The reservoir according to claim 1, wherein the polyethylene is cross-linked using a cross-linking process selected from a group of processes consisting of peroxide cross-linking, silane cross-linking, and cross-linking under the influence of radiation energy.

3. The reservoir according to claim 1, wherein the degree of cross-linking of the polyethylene is 5 to 95%.

4. The reservoir according to claim 1, wherein an outer layer of the wall is formed as a reinforcement layer.

5. The reservoir according to claim 4, wherein the reinforcement layer contains a filament or a thread made of a material selected from a group of materials consisting of carbon, aramid, metal, boron, glass, a silicate material, aluminum oxide, a highly ductile and highly temperature-resistant polymer material, and a mixture of the aforementioned.

6. The reservoir according to claim 4, wherein the reinforcement layer made of the filament or the thread is wrapped and/or braided.

7. The reservoir according to claim 4, wherein the outer layer contains a polymer material, preferably an epoxy resin.

8. The reservoir according to claim 1, wherein there is a barrier layer for reducing the diffusion of the fluid through the wall.

9. The reservoir according to claim 8, wherein the barrier layer is provided on the inner surface of the inner layer.

10. The reservoir according to claim 9, wherein the barrier layer is a polymer selected from a group of barrier layers consisting of ethylene vinyl alcohol (EVOH), a film, a coating, in particular based on a silazane, and a combination of the aforementioned.

11. The reservoir according to claim 1, wherein the thickness of the barrier layer is between 0.1 and 1000 μm.

12. The reservoir according to claim 1, wherein an outer protective layer is provided which is applied onto the outer layer of the wall.

13. The reservoir according to claim 12, wherein the outer protective layer contains a thermoplastic, or a coextrudate, or a shrink tubing, or a knitted fabric, or an interlaced fabric, or a meshwork, or a combination of the aforementioned.

14. A method for producing a reservoir according to claim 1, wherein the inner layer is produced by means of the blow molding method using polyethylene and is cross-linked after molding.

15. A fluid supply system comprising at least one reservoir according to claim 1, preferably for use in a motor vehicle or a stationary or mobile, in particular, decentralized energy generating device or an energy storage system.

16. The reservoir according to claim 1 wherein the degree of cross-linking of the polyethylene is 15 to 90%.

17. The reservoir according to claim 1 wherein the degree of cross-linking of the polyethylene is 50 to 85%.

18. The reservoir according to claim 2 wherein the degree of cross-linking of the polyethylene is 15 to 90%.

19. The reservoir according to claim 2 wherein the degree of cross-linking of the polyethylene is 50 to 85%.

20. The reservoir according to claim 2, wherein an outer layer of the wall is formed as a reinforcement layer.
